(19) United States
(12) Patent Application Publication
(10) Pub. No.: US 2026/0336464 A1
(43) Pub. Date: Oct. 29, 2026

(54) SYSTEM AND METHOD FOR DETERMINING A STATUS PERIOD OF A CHARGING POINT

(71) Applicant: HERE GLOBAL B.V., EINDHOVEN (NL)

(72) Inventors: Amarnath Nayak, MUMBAI (IN); Bruce Bernhardt, WAUCONDA, IL (US)

(73) Assignee: HERE GLOBAL B.V., EINDHOVEN (NL)

(21) Appl. No.: 19/211,343

(22) Filed: May 19, 2025

Related U.S. Application Data
(63) Continuation of application No. 19/188,066, filed on Apr. 24, 2025, now abandoned.

(51) Int. Cl. B60L 53/68; B60L 53/62; B60L 53/67; G01C 21/34

(52) U.S. Cl. CPC B60L 53/68; B60L 53/62; B60L 53/67; G01C 21/3469; B60L 2240/62; B60L 2240/68; B60L 2240/72

(57) ABSTRACT

An apparatus and a method for determining a status period of a charging point are provided. The apparatus receives charging point data associated with a charging point. The charging point data indicates one or more status types associated with the charging point and one or more periods associated with each of the one or more status types. The apparatus further determines error data associated with each of the one or more status types based on the charging point data. The apparatus further determines status period data associated with each of the one or more status types based on the error data, the status period data indicating an estimated period of each of the one or more status types. The apparatus further outputs the status period data.

### CROSS-REFERENCE TO RELATED APPLICATIONS

This application is a Continuation-in-Part of U.S. patent application Ser. No. 19/188,066 filed on Apr. 24, 2025, the contents of each of which are incorporated by reference in their entirety.

### TECHNOLOGICAL FIELD

An example embodiment of the present disclosure relates to predicting a status period of a charging point, and more particularly, to determining status period data for different status types of the charging point based on error data associated with the status types.

### BACKGROUND

As electric vehicles (EVs) gain popularity, the need for efficient and reliable charging infrastructure becomes increasingly critical. One of the primary concerns for EV users is range anxiety, which stems from uncertainties about the availability and accessibility of charging points. This anxiety is often compounded by the lack of real-time information regarding the status of charging points. EV users frequently encounter situations where they arrive at a charging point only to find that all connectors are occupied, leading to frustration and extended wait times.

Current navigation and charging applications typically provide estimates of connector availability based on historical data and usage patterns. However, these estimates may be misleading, as they do not account for real-time fluctuations in connector status. Factors, such as varying charging times and unexpected outages may significantly impact the actual wait time for EV users. Consequently, the inability to accurately predict wait times at the charging points may deter potential EV adopters and hinder the overall growth of electric mobility.

Thus, it would be beneficial to have accurate and real-time information on charging points, specifically, waiting time associated with the charging point, so that EV users can be better prepared for their travel and also be able to opt for safer and greener modes of travel, such as the electric vehicles, without worrying about limitations of green technologies and solutions.

### BRIEF SUMMARY OF SOME EXAMPLE EMBODIMENTS

An apparatus, a method, and a computer-programmable product are provided for determining the status period data of a charging point.

In one aspect, an apparatus for determining the status period data of a charging point is disclosed. The apparatus includes at least one processor and at least one non-transitory memory storing computer program code instructions. The computer program code instructions are configured to, when executed, cause the apparatus to receive charging point data associated with a charging point. The charging point data indicates one or more status types associated with the charging point and one or more periods associated with each of the one or more status types. The computer program code instructions are further configured to, when executed, cause the apparatus to determine error data associated with each of the one or more status types based on the charging point data. The computer program code instructions are further configured to, when executed, cause the apparatus to determine status period data associated with each of the one or more status types based on the error data. The status period data indicates an estimated period of each of the one or more status types. The computer program code instructions are further configured to, when executed, cause the apparatus to output the status period data.

In some example embodiments, the one or more status types include a charging status type, an available status type, an unknown status type, an inoperative status type, a blocked status type, or a combination thereof.

In some example embodiments, to determine the error data, the computer program code instructions are configured to, when executed, cause the apparatus to determine a number of events corresponding to each of the one or more status types. The computer program code instructions are further configured to, when executed, cause the apparatus to determine a deviation value associated with each of the one or more status types based on the one or more periods and the number of events. The computer program code instructions are further configured to, when executed, cause the apparatus to determine the error data based on the deviation value and the number of events.

In some example embodiments, the error data is a ratio of the deviation value and a value based on the number of events.

In some example embodiments, to determine the status period data, the computer program code instructions are configured to, when executed, cause the apparatus to determine median period data associated with each of the one or more status types based on the one or more periods. The computer program code instructions are further configured to, when executed, cause the apparatus to determine elapsed period data for each one of the one or more status types. The elapsed period data indicates an amount of period elapsed since an occurrence of a status type that directly precedes a starting time of one of the one or more status types. The computer program code instructions are further configured to, when executed, cause the apparatus to determine the status period data based on the median period data, the elapsed period data, and the error data.

In some example embodiments, the charging point data includes geographical region data associated with a geographical region of the charging point.

In some example embodiments, the computer program code instructions are further configured to, when executed, cause the apparatus to retrieve traffic data associated with the geographical region based on the charging point data. The computer program code instructions are further configured to, when executed, cause the apparatus to determine travel data for each one of a plurality of predefined periods based on the traffic data. The travel data indicates a distance traveled by one or more vehicles within the geographical region during one of the plurality of predefined periods. The computer program code instructions are further configured to, when executed, cause the apparatus to determine a correction factor for a first predefined period of the plurality of predefined periods based on the travel data. The computer program code instructions are further configured to, when executed, cause the apparatus to update the status period data associated with each of the one or more status types based on the correction factor. The computer program code instructions are further configured to, when executed, cause the apparatus to output the updated status period data.

In some example embodiments, the travel data for each of the plurality of predefined periods defines, in part, travel graph data including a travel plot. The computer program code instructions are further configured to, when executed, cause the apparatus to apply one or more predefined thresholds to the travel graph data. The computer program code instructions are further configured to, when executed, cause the apparatus to determine a vehicle distance travel value associated with the predefined period of the plurality of predefined periods based on the travel graph data. Responsive to the vehicle distance travel value satisfying one of the one or more predefined thresholds, the computer program code instructions are further configured to, when executed, cause the apparatus to determine the correction factor based on said one of the one or more predefined thresholds and the vehicle distance travel value.

In some example embodiments, the correction factor is a ratio of said one of the one or more predefined thresholds and the vehicle distance travel value.

In some example embodiments, the computer program code instructions are further configured to, when executed, cause the apparatus to receive cluster data associated with each cluster of a plurality of clusters. Each cluster of the plurality of clusters includes one or more charging points. A cluster of the plurality of clusters includes the charging point. The computer program code instructions are further configured to, when executed, cause the apparatus to determine the status period data for each of the one or more charging points of each of the plurality of clusters.

In some example embodiments, the computer program code instructions are further configured to, when executed, cause the apparatus to receive vehicle information of a vehicle. The vehicle information includes location data and battery charge data. The computer program code instructions are further configured to, when executed, cause the apparatus to determine availability data associated with each of the one or more charging points within each of the plurality of clusters based on the status period data for each of the one or more charging points of each of the plurality of clusters. The computer program code instructions are further configured to, when executed, cause the apparatus to identify at least one charging point from at least one cluster of the plurality of clusters for the vehicle based on the vehicle information and the availability data.

In some example embodiments, the computer program code instructions are further configured to, when executed, cause the apparatus to generate navigation instructions for the vehicle from a starting location to one of the at least one identified charging point.

In another aspect, a method for the determination of status period data of a charging point is disclosed. The method includes receiving charging point data associated with a charging point. The charging point data indicates one or more status types associated with the charging point and one or more periods associated with each of the one or more status types. The method further includes determining error data associated with each of the one or more status types based on the charging point data. The method further includes determining status period data associated with each of the one or more status types based on the error data. The status period data indicates an estimated period of each of the one or more status types. The method further includes outputting the status period data.

In yet another aspect, a computer programmable product for the determination of status period data of a charging point is disclosed. The computer programmable product includes a non-transitory computer readable medium having stored thereon computer executable instructions. The computer executable instructions, which when executed by one or more processors, cause the one or more processors to carry out operations. The operations include receiving charging point data associated with a charging point. The charging point data indicates one or more status types associated with the charging point and one or more periods associated with each of the one or more status types. The operations further include determining error data associated with each of the one or more status types based on the charging point data. The operations further include determining status period data associated with each of the one or more status types based on the error data. The status period data indicates an estimated period of each of the one or more status types. The operations further include outputting the status period data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment in which an apparatus for determining status period data associated with a charging point is implemented, in accordance with an embodiment of the disclosure;

FIG. 2 illustrates a block diagram of the apparatus of FIG. 1, in accordance with an embodiment of the disclosure;

FIG. 3 is a block diagram that illustrates exemplary operations for determining the status period data associated with the charging point, in accordance with an embodiment of the disclosure;

FIG. 4A is a block diagram that illustrates exemplary operations for updating the status period data associated with the charging point, in accordance with an embodiment of the disclosure;

FIG. 4B is a block diagram that illustrates exemplary operations for determining a correction factor associated with each of one or more status types, in accordance with an embodiment of the disclosure;

FIG. 4C is a diagram of a graphical representation of travel graph data, in accordance with an embodiment of the disclosure;

FIG. 5 is a flowchart that illustrates an exemplary method for determining status period data for a plurality of clusters, in accordance with an embodiment of the disclosure;

FIG. 6 is a block diagram that illustrates exemplary operations for generating navigation instructions, in accordance with an embodiment of the disclosure;

FIG. 7A is a diagram that illustrates a first user interface associated with rendering the status period data for a vehicle, in accordance with an embodiment of the disclosure;

FIG. 7B is a diagram that illustrates a second user interface associated with rendering a recommendation for the charging of the vehicle, in accordance with an embodiment of the disclosure;

FIG. 7C is a diagram that illustrates a third user interface associated with rendering a recommendation for charging a vehicle, in accordance with an embodiment of the disclosure; and

FIG. 8 is a flowchart that illustrates an exemplary method for determining the status period data associated with the charging point, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present invention. Thus, the use of any such terms should not be taken to limit the spirit and scope of embodiments of the present invention.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

As discussed previously, range anxiety is a primary concern for EV users. A critical aspect of range anxiety is the uncertainty surrounding the availability of charging points. While advancements in charging technology and infrastructure have improved the overall experience for EV users, challenges remain regarding the predictability of charging point availability. Users often rely on mobile applications and navigation systems to locate nearby charging points, but these tools may not provide real-time information about the status of charging connectors. As a result, users may arrive at a charging point only to find that a desired connector is unavailable due to the charging point being used by other vehicles, being under maintenance, or being inoperative, leading to frustration and extended wait times.

Moreover, even when a charging point appears to be available, there may be additional delays due to the charging duration of the previous vehicle. This unpredictability may deter potential EV users from making the switch to EVs, as the perceived inconvenience of charging may outweigh the benefits of driving an EV. The lack of accurate, real-time data on charging station status contributes to this problem, as users are left to make decisions based on outdated or incomplete information.

In addition to the psychological barriers posed by range anxiety, the physical limitations of charging infrastructure also play a role. Many urban areas lack sufficient charging stations to meet the growing demand for electric vehicles, leading to congestion at available charging points. This situation is further complicated by the varying charging connector types and charging speeds of different electric vehicles and charging points of charging stations, which may result in longer-than-expected wait times for users.

Overall, the combination of range anxiety, uncertainty about charging station availability, and the limitations of existing infrastructure presents significant challenges to the adoption of EVs. Addressing these issues is crucial for fostering the transition to sustainable transportation solutions, i.e., EVs, and ensuring seamless operation of currently deployed EVs.

To solve the foregoing problem, the present disclosure may provide systems and methods that determine the accurate status period associated with a charging point. By leveraging real-time data on the status of the charging point, the present disclosure may provide users with precise estimates of how long the charging connector will remain in its current state. This may be further used to determine the wait time for the availability of the charging point, thereby enabling a user to estimate how long they may need to wait before accessing the charging point. The proposed solution utilizes dynamic time series data that reflects different operational states of the charging point, including whether the charging point is in use, available, out-of-order, or undergoing maintenance. By analyzing this data, the present disclosure may predict the wait time for the availability of the charging point more accurately than conventional methods, which often rely on historical usage patterns alone. This real-time information empowers the electric vehicle users to make informed decisions about their charging needs, reducing uncertainty and enhancing the overall user experience.

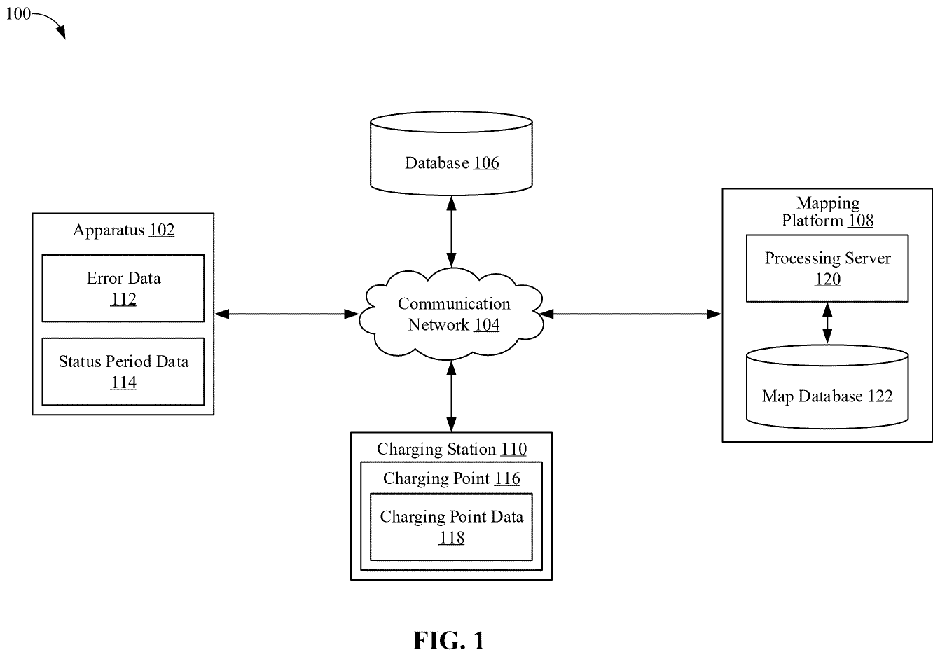

FIG. 1 is a diagram that illustrates a network environment 100 in which an apparatus 102 for determining status period data associated with a charging point 116 is implemented, in accordance with an embodiment of the disclosure. The network environment 100 includes the apparatus 102, a database 106, a mapping platform 108, a communication network 104, and a charging station 110. The apparatus 102 may generate and store error data 112 and status period data 114. Further, the charging station 110 may include the charging point 116. The mapping platform 108 may include a processing server 120 and a map database 122.

The apparatus 102 may include suitable logic, circuitry, interfaces, and/or code that may be configured to receive charging point data 118 associated with the charging point 116. The charging point data 118 indicates one or more status types associated with the charging point 116 and one or more periods associated with each of the one or more status types. The apparatus 102 is further configured to determine error data 112 associated with each of the one or more status types based on the charging point data 118. The apparatus 102 is further configured to determine status period data 114 associated with each of the one or more status types based on the error data 112. The status period data 114 indicates an estimated period of each of the one or more status types. In an example, the error data 112 and the status period data 114 may be stored within the apparatus 102, and/or the database 106. The apparatus 102 is further configured to output the status period data 114. Examples of the apparatus 102 may include, but are not limited to, an electronic control unit (ECU) of the specific EV, an electronic control module (ECM) of the specific EV, a computing device, a mainframe machine, a server, a computer workstation, a mobile device, any and/or any other device with vehicle charging recommendation operations.

In an example embodiment, the apparatus 102 may be on-boarded by a vehicle, such as the apparatus 102 may be a charging recommendation system installed in the vehicle for determination of the status period data 114 of the charging point 116. In another example embodiment, the apparatus 102 may be the processing server 120 of the mapping platform 108 and therefore may be co-located with or within the mapping platform 108.

In another embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. The OEM cloud may be configured to anonymize any data received by the apparatus 102, such as from the vehicle, and traffic congestion information before using the data for further processing, such as before sending the data to the map database 122. For example, anonymization of the data may be done by the mapping platform 108.

The mapping platform 108 may include suitable logic, circuitry, and interfaces that may be configured to store one or more map attributes and sensor data associated with traffic on a set of lane segments and/or a set of link segments. The mapping platform 108 may be configured to store and update map data indicating the traffic data along with other map attributes, road attributes, and traffic entities, in the map database 122. The mapping platform 108 may include techniques related to, but not limited to, geocoding, routing (multimodal, intermodal, and unimodal), clustering algorithms, machine learning (ML) in location-based solutions, natural language processing (NLP) algorithms, and artificial intelligence (AI) algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chipset. In other words, the mapping platform 108 may include one or more physical packages (such as chips) that include materials, components, and/or wires on a structural assembly (such as a baseboard).

In some example embodiments, the mapping platform 108 may include the processing server 120 for carrying out the processing functions associated with the mapping platform 108 and the map database 122 for storing map data. In an embodiment, the processing server 120 may include one or more processors configured to process requests received from the apparatus 102. The processors may fetch sensor data and/or map data from the map database 122 and transmit the same to the apparatus 102 in a format suitable for use by the apparatus 102.

Continuing further, the map database 122 may include suitable logic, circuitry, and interfaces that may be configured to store the sensor data and map data, which may be collected from one or more vehicles. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 122 of features within an environment that is appropriate for mapping and/or traffic-related services. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The map database 122 may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 122 may be configured to receive the map data including the road topology and geometry-related attributes related to the road network from external systems, such as one or more background batch data services, streaming data services, and third-party service providers, via the communication network 104.

In accordance with an embodiment, the map data stored in the map database 122 may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 122 may further store historical probe data for events (such as, but not limited to, traffic incidents, construction activities, scheduled events, and unscheduled events) associated with Point of Interest (POI) data records or other records of the map database 122.

For example, the data stored in the map database 122 may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for two-wheeler travel, bicycle travel along bike paths, etc. The compilation to produce the end-user databases may be performed by a party or entity separate from the map developer. For example, a customer of the map developer, such as a navigation device developer or other end user device developer, may perform compilation on the received map database 122 in a delivery format to produce one or more compiled navigation databases.

In some embodiments, the map database 122 may be a master geographic database configured on the side of the apparatus 102. In accordance with an embodiment, the map database 122 may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 122.

For example, the map database 122 may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 122 may additionally include data about places, such as cities, towns, or other communities, and other geographic features such as, but not limited to, bodies of water, and mountain ranges.

In some example embodiments, images received from an image source may be stored within the map database 122 of the mapping platform 108. In certain cases, the mapping platform 108, using the processing server 120, may suitably process the received images. For example, such processing may include, suitably labeling the images based on the corresponding associated lane and/or link, point of interest within the link and/or lane, and other information relating to the respective link and/or lane. Such labeled images may then be stored within the map database 122 as map data.

The communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU)-international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an embodiment, the database 106 is a structured collection of data that enables efficient storage, retrieval, and management of information, often organized in a way that facilitates easy access and manipulation. The database 106 is structured to facilitate quick access and manipulation of data through a Database Management System (DBMS). The database 106 is configured to store the information, including the error data 112 and the status period data 114. The error data 112 indicates a range of possible values around a measured or calculated value, representing an uncertainty or a potential error in the measured or calculated value. Additionally, the status period data 114 indicates a period for which each status type of the one or more status types may persist at the charging point 116 during its operation. Furthermore, the database 106 is configured to store output generated during the processes performed by the apparatus 102. This output may include results from data analyses, user interactions, and system-generated reports. By maintaining a detailed record of this information, the database 106 enables the apparatus 102 to provide users with timely and relevant insights, enhancing the overall user experience. The structured nature of the database 106 provides quick access to this information, allowing for efficient data retrieval and manipulation.

In an embodiment, the one or more status types associated with the charging point 116 represent the operational condition(s) of the charging point 116 associated with the charging station 110. The one or more status types indicate information about, for example, availability and other operational states of the charging point 116 of the charging station 110. The operational states of the charging point 116 may indicate that the charging point 116 is in use, available for charging, or experiencing issues that may prevent its use. The operational states of the charging point 116 may allow an EV user or an administrator to make informed decisions based on real-time data.

In operation, the apparatus 102 is configured to receive the charging point data 118 associated with the charging point 116. In an embodiment, the apparatus 102 may receive the charging point data 118 from the charging station 110. In another embodiment, the apparatus 102 may be configured to receive the charging point data 118 from the database 106. In an example, the charging point data 118 may correspond to time series data for one or more periods. In an embodiment, the charging point data 118 indicates one or more status types associated with the charging point 116 and one or more periods associated with each of the one or more status types. In an embodiment, the charging station 110 may include one or more charging points, such as the charging point 116. The charging point 116 may allow a user to charge their EV with the help of a connector. The charging station 110 may include one or more charging points to charge one or more EVs at the same time.

Further, the apparatus 102 is configured to determine the error data 112 associated with each of the one or more status types based on the charging point data 118. In an embodiment, the determination of the error data 112 associated with each status type of one or more status types allows the apparatus 102 to identify uncertainty or potential deviations that may be present in calculated values of the time period of occurrence of the respective status type.

The charging point data 118 includes the duration of occurrence of each status type of the one or more status types, timestamps for transitions from a first status type of the one or more status types to a second status type of the one or more status types, and any recorded anomalies or interruptions during any occurrence of any of the one or more status types. By examining the charging point data 118, the apparatus 102 may determine the error data 112 indicating, for example, deviations in expected time periods of status types.

For example, if the charging point 116 is expected to remain in a “charging” status for a specified duration but instead transitions to “available” or “inoperative” prematurely, i.e., before the completion of the specified duration, the apparatus 102 may capture this deviation. Subsequently, the error data 112 is determined based on such deviation. This analysis not only highlights potential malfunctions but also provides insights into operational inefficiencies, such as user behavior that may lead to blocked connectors or improper usage patterns.

Further, the apparatus 102 is configured to determine the status period data 114 associated with each of the one or more status types based on the error data 112. The status period data 114 indicates an estimated period of each of the one or more status types. In an embodiment, the status period data 114 provides an estimated period for which a status type of the one or more status types is expected to persist or occur. This may indicate the operational dynamics of the charging point 116. By utilizing the error data 112, which reflects deviations in the pre-calculated value of a duration of occurrence of each of the one or more status types, the apparatus 102 may make accurate predictions about how long a charging point 116 will remain in a particular status type of the one or more status types.

In an example, the apparatus 102 may also analyze historical data to predict or calculate the pre-calculated value of the duration of occurrence of each of the one or more status types. However, the pre-calculated values based on the historical data may not provide accurate time duration, i.e., status period of different status types owing to various changing dynamic conditions. These dynamic conditions may include, for example, change in traffic, occurrence of an event, extended charging activities of EVs, and so forth. If, for example, the error data 112 indicates that the pre-calculated value for the “charging” status type may get extended by a five-minute window, the apparatus 102 may adjust its prediction, i.e., the pre-calculated value for the “charging” status type, based on this pattern to determine a status period for the “charging” status type. This predictive capability enhances user experience by providing real-time and accurate information about a duration for which a particular status type of the one or more status types may persist at the charging point 116, thereby reducing uncertainty and wait times.

In addition to the “charging” status type, the apparatus 102 may determine status period data 114 for other status types, such as “available,” “inoperative,” “under maintenance,” or “blocked.” For example, if a charging point 116 is currently in the “charging” status and the error data 112 suggests that it typically takes an average of 30 minutes to charge a type of the vehicle being currently charged given the specification of the charging point 116, the apparatus 102 may estimate that the charging point 116 will remain in this status for approximately 30 more minutes.

By providing the status period data 114, the apparatus 102 enhances the overall efficiency of the charging infrastructure. Users may make informed decisions about when to arrive at the charging station 110, how much waiting time to expect, and whether the user should go to the charging station 110 or the charging point 116 for charging. In addition, operators may better manage resources and anticipate demand.

Further, the apparatus 102 is configured to output the status period data 114. The apparatus 102 provides information about the expected duration of occurrence of each status type associated with the charging point 116 by way of the status period data 114. In one embodiment, the apparatus 102 is configured to store the status period data 114 into the database 106, ensuring that historical and real-time information is readily accessible for analysis and reporting. This stored status period data 114 may be further used for downstream processing, such as trend analysis, performance monitoring, and strategic planning regarding charging infrastructure.

In an example, the apparatus 102 may be configured to output the status period data 114 to the mapping platform 108. This integration enables EV users searching for charging stations to access real-time information about the availability and expected duration of each charging point's status. For instance, if a user is looking for a nearby charging station such as the charging station 110, the mapping platform 108 may display not only the location of the station but also indicate whether the charging point 116 is currently available, charging, or inoperative, along with the estimated time for the occurrence of a current status type. For example, if the charging station 110 is near the user but is currently in the “charging” status type and is most likely going to remain in the charging status type when the user reaches there, the mapping platform 108 may inform the user about a different charging station which is predicted to have the “available” status type when the user reaches said charging station, or the mapping platform 108 may inform the user about a wait time associated with the charging station 110 for transitioning from the “charging” status type to “available” status type. This enhances the user experience by reducing uncertainty and allowing EV users to make informed decisions about where to charge their vehicles.

Additionally, the apparatus 102 may be configured to send the status period data 114 or a part thereof to mobile applications designed for EV users. Such applications could provide notifications or alerts when the charging point 116 is about to transition to, or transitions to the “available” status type, allowing users to receive timely updates and plan their charging stops more effectively. Furthermore, the apparatus 102 could integrate with smart city infrastructure, enabling real-time data sharing with traffic management systems. This integration could optimize traffic flow by directing EV users to the nearest available charging stations, thereby reducing congestion and improving overall urban mobility.

Moreover, the apparatus 102 may share the status period data 114 with third-party service providers, such as ride-sharing or fleet management companies. By using the status period data 114, these companies may optimize their operations, ensuring that their electric vehicles are charged efficiently and ready for use when needed. This capability could also extend to partnerships with energy providers, allowing for better demand management and load balancing on the electrical grid.

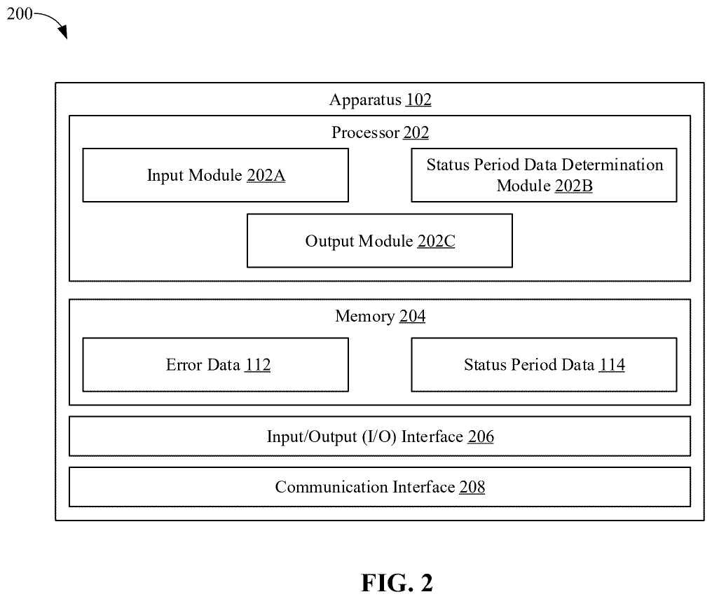

FIG. 2 illustrates a block diagram 200 of the apparatus 102 of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor (referred to as a processor 202, hereinafter), at least one non-transitory memory (referred to as a memory 204, hereinafter), an input/output (I/O) interface 206, and a communication interface 208. The processor 202 may include modules, depicted as, an input module 202A, a status period data determination module 202B, and an output module 202C. The apparatus 102 may be connected to the memory 204, the I/O interface 206, and the communication interface 208 through wired or wireless connections. Although FIG. 2 illustrates that the apparatus 102 includes the processor 202, the memory 204, the I/O interface 206, and the communication interface 208, the disclosure may not be so limiting, and the apparatus 102 may include fewer or more components to perform the same or other functions of the apparatus 102. In an embodiment, the input module 202A and the output module 202C may be integrated within the I/O interface 206. In some embodiments, the input module 202A may receive input data (such as the charging point data 118), and the output module 202C may output processed data (such as the status period data 114 associated with the one or more status types) via the I/O interface 206.

In accordance with an embodiment, the apparatus 102 may store data that may be generated by the modules while performing corresponding operations or may be retrieved from a database, such as the database 106 or the map database 122 associated with the apparatus 102 in the memory 204. For example, the data may include vehicle information, traffic information, user information, distance information, and environmental information.

The processor 202 of the apparatus 102 may be configured to determine the status period data 114 for each of the status types, and output the determined status period data 114. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using the communication interface 208 of the apparatus 102. The communication interface 208 may provide an interface for accessing various features and data stored in the apparatus 102.

In some embodiments, the processor 202 may be configured to provide Internet-of-Things (IoT) related capabilities to users of the apparatus 102 disclosed herein. The IoT-related capabilities may in turn be used to provide smart city solutions by providing the status period of each of the one or more status types associated with the one or more charging, real-time warnings, big data analysis, and sensor-based data collection by using the cloud-based mapping system for providing accurate navigation instructions and ensuring driver safety. The I/O interface 206 may provide an interface for accessing various features and data stored in the apparatus 102.

The input module 202A of the processor 202 may be configured to receive charging point data 118 associated with the charging point 116. In an embodiment, the charging point data 118 associated with the charging point 116 is received from the map database 122. In an alternate embodiment, the charging point data 118 associated with the charging point 116 is received from one or more sensors associated with the charging point 116. In some cases, the one or more sensors may be installed at the charging station 110 which includes one or more charging points including the charging point 116, and the one or more sensors may be configured to receive the charging point data 118 associated with each of the one or more charging points.

The status period determination module 202B of the processor 202 may be configured to determine the status period data 114 associated with each status type of the one or more status types. The status period determination module may provide accurate estimates of how long each status type is expected to persist, occur, or last. In an embodiment, the status period determination module 202B may configured to determine the status period data 114 associated with each of the one or more status types based on real-time charging point data 118 and historical data associated with the charging station 110 as well as the one or more status types.

For example, if the historical data indicates that the charging point 116 has consistently remained in the “charging” status for an average of 30 minutes, the status period determination module 202B may use this information to predict future charging durations while accounting for any variability. Similarly, if the historical data shows that the charging point 116 frequently transitions to “available” status after a specific time frame, the status period determination module 202B may incorporate this pattern into its calculations, reflecting the expected fluctuations. By leveraging both real-time and historical data, the status period determination module 202B may provide more accurate and contextually relevant estimates of status periods or time durations for the occurrence of each of the one or more status types at the charging point 116.

The output module 202C of the processor 202 is configured to output the determined status period data 114 associated with each of the one or more status types for the charging point 116. In an embodiment, the output module 202C generates visual representations, such as virtual objects, that indicate the predicted status period data 114 of the charging point 116. The status period data 114 may be used to determine and output, for example, an expected duration of an occurrence of a current status type, an expected time of becoming the charging point 116 available for charging, an expected time duration of waiting at the charging station 110 after reaching for using the charging point 116, or a combination thereof. This functionality allows users to quickly assess the situation of the charging point 116 at a glance. Additionally, the output module 202C may be configured to alert users about significant status changes or provide recommendations based on the analyzed data. For instance, if the charging point 116 is predicted to become available soon, the output module 202C may send notifications to users, guiding them to the most the charging point 116. This may provide minimal waiting time for the user as well as ensure optimal utilization of charging infrastructure.

The output module 202C may be implemented through various channels, including visual displays and audio alerts on the I/O interface 206 of the apparatus 102, ensuring that users receive relevant information timely. Furthermore, the output module 202C may transmit the predicted status of charging point 116 and any generated recommendations to the map database 122, enhancing the overall user experience by integrating real-time data into navigation systems. This integration allows users to make informed decisions about their charging needs while on the road. In another embodiment, the output module 202C may also control the maneuvering of electric vehicles to optimize their driving range based on the status of nearby charging points, ensuring that users can efficiently manage their charging requirements and travel plans.

The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein. In an embodiment, the error data 112 and the status period data 114 are stored in the memory 204 of the apparatus 102.

In some example embodiments, the I/O interface 206 may communicate with the apparatus 102 and display the input and/or output of the apparatus 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface circuitry including the processor 202 may be configured to control one or more functions of the one or more I/O interface elements through computer program instructions (for example, software and/or firmware) stored on the memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may include an input interface and output interface for supporting communications to and from the apparatus 102 or any other component with which the apparatus 102 may communicate. The communication interface 208 may be any means such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning.

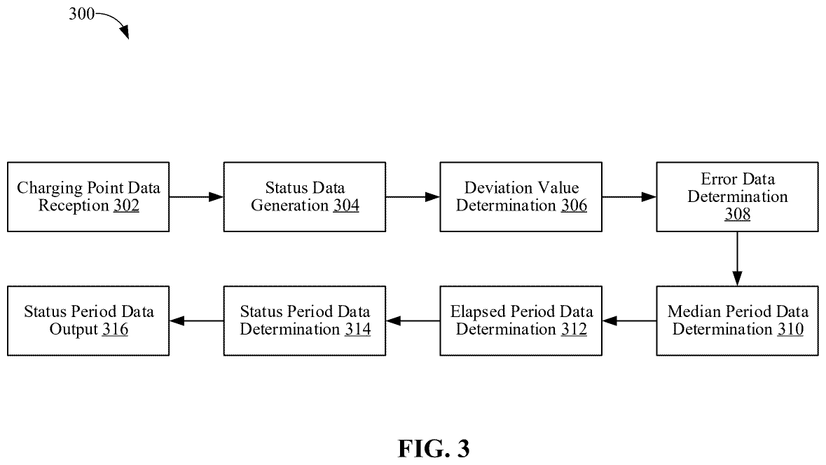

FIG. 3 is a block diagram 300 that illustrates exemplary operations for determining the status period data 114 associated with the charging point 116, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 316, as described herein. The exemplary operations illustrated in the block diagram 300 may start at 302 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a charging point data reception operation may be executed. In the charging point data reception operation, the apparatus 102 may be configured to receive the charging point data 118 associated with the charging point 116. The charging point data 118 indicates one or more status types associated with the charging point 116. In addition, the charging point data 118 indicates one or more periods associated with each of the one or more status types. Specifically, the input module 202A of the processor 202 may be configured to receive the charging point data 118 associated with the charging point 116.

The charging point data 118 may include time series data associated with different status types observed at the charging point 116. The time series data provides a chronological record of the operational states of the charging point 116 corresponding to different status types, allowing for a detailed analysis of usage of the charging point 116 over time. Each entry in the time series data includes specific timestamps that denote a starting time and an ending time associated with an occurrence of a status type of the one or more status types. This temporal information is crucial for understanding how long a connector remains in a particular state, i.e., a status type.

In addition to the time series data, the charging point data 118 includes a unique identification number associated with the charging station 110. This identification number serves as a distinct reference for each of one or more charging points of the charging station 110. The unique identification number is essential for data integrity and ensures that all information related to the charging station 110 and its specific charging point (e.g., the charging point 116) is stored together.

Furthermore, the charging point data 118 may include a start time and an end time associated with each of the one or more status types of the charging point 116. For instance, the charging point data 118 may include a duration, the start time, and the end time associated with each status type of the one or more status types that may have occurred at the charging point 116. The duration of an occurrence of a specific status type indicates the length of time for which the charging point 116 remains in the specific status type. The start time indicates a timestamp at which the occurrence of the specific status type started while the end time indicates the occurrence of the specific status type ended.

Additionally, the charging point data 118 may include geographical region data associated with a geographical region of the charging point 116. The geographical region data may indicate a location identification number, which may provide the precise geographic positioning of the geographical region of the charging point 116.

In an embodiment, the one or more status types include a charging status type, an available status type, an unknown status type, an inoperative status type, a blocked status type, or a combination thereof. In an example, the charging status type indicates that the charging point 116 is actively supplying power to an EV, i.e., charging the EV. The charging status type signifies that the charging point 116 is operational and in use. The available status type denotes that the charging point 116 is unoccupied and ready for immediate use. Further, the unknown status type indicates that a status or an operational state of the charging point 116 cannot be determined due to communication errors or data transmission issues. The inoperative status type indicates that the charging point 116 is not functioning correctly and cannot be used for charging. The inoperative status type may arise from technical malfunctions or maintenance requirements. Lastly, the blocked status type signifies that the charging point 116 is physically obstructed, preventing access to a connector of the charging point 116. This could occur due to improper parking or other physical barriers. Exemplary charging status data 118 for the charging point 116, having a location ID, for example, ‘Ab82c-11ed-40fc0’ and a charging point ID, for example, ‘1135917′1’ is shown in Table T1.

TABLE T1
Charging Point Data

| | Location | Charging | Start | End | | | Duration |
|---|---|---|---|---|---|---|---|
| | ID | Point ID | Status | Status | Start Time | End Time | (in sec) |
| 1. | Ab82c- | 1135917′1 | Available | Uncertain | 2025 Jan. 2 | 2025 Jan. 2 | 304296 |
| | 11ed- | | | | 21:38:58 | 21:38:58 | |
| | 40fc0 | | | | | | |
| 2. | Ab82c- | 1135917′1 | Uncertain | Available | 2025 Jan. 2 | 2025 Jan. 2 | 28 |
| | 11ed- | | | | 21:38:58 | 21:38:58 | |
| | 40fc0 | | | | | | |
| 3. | Ab82c- | 1135917′1 | Available | Charging | 2025 Jan. 2 | 2025 Jan. 2 | 890 |
| | 11ed- | | | | 21:38:58 | 21:38:58 | |
| | 40fc0 | | | | | | |
| 4. | Ab82c- | 1135917′1 | Charging | Available | 2025 Jan. 2 | 2025 Jan. 2 | 606 |
| | 11ed- | | | | 21:38:58 | 21:38:58 | |
| | 40fc0 | | | | | | |
| 5. | Ab82c- | 1135917′1 | Available | Charging | 2025 Jan. 2 | 2025 Jan. 2 | 450218 |
| | 11ed- | | | | 21:38:58 | 21:38:58 | |
| | 40fc0 | | | | | | |

It may be noted that the location ID in the charging point data 118 corresponds to a location or geographical region of the charging station 110. Further, as the charging station 110 may also include other charging points, charging station data may also be gathered for other charging points of the charging station 110. In such a case, the charging point ID in the charging point data of the other charging points may be different from the charging point ID of the charging point 116.

For example, the charging point data 118 may include a location ID indicating a unique identifier associated with a geographical region or location of the charging station 110 and the charging point 116. Additionally, the charging point data 118 may include a charging point ID which indicates a unique identifier for the specific charging point 116 within the charging station 110. For example, a charging point ID such as “1135917′1” indicates a unique identifier where the initial digits represent the identification number of the charging station 110 itself. Further, the charging point data 118 may include a start status that corresponds to each occurrence of a status type from the one or more status types. The start status reflects an operational condition of the charging point 116 at a given time, providing context for the charging point's current activity. Further, the charging point data 118 may include an end status that indicates the operational status of the charging point 116 at the conclusion of a defined period, allowing for an understanding of how the charging point's status has changed over time. Further, the charging point data 118 may include a start time that corresponds to the starting time of a specific status type from the one or more status types. Further, the charging point data 118 may include an end time which indicates the ending time associated with the specific status type of the one or more status types. Further, the charging point data 118 may include a duration that corresponds to the period of a specific status type of the one or more status types. The start time and the end time are utilized for analyzing the duration of each status, which is captured in the duration field. This duration corresponds to a total period in which a specific status type was occurring.

At 304, a status data generation operation may be executed. In the status data generation operation, the apparatus 102 is configured to generate status data associated with each of the one or more status types. In an example, the processor 202 is configured to generate the status data for the charging point 116 based on the received charging point data 118. The apparatus 102 may be configured to classify the received charging point data 118 into distinct status data categories, each corresponding to a specific status type from the one or more status types relevant to the charging infrastructure.

For instance, as illustrated in Table T1, the apparatus 102 may classify and create separate tables for each of the status types, allowing for a structured representation of the charging point data 118. This classification process involves filtering the charging point data 118 to isolate entries that correspond to specific operational conditions. For example, the status data associated with the available status type would include all entries where the start status is marked as “available.” This means that any time the charging point 116 is unoccupied and ready for use, the relevant data entries would be aggregated into this category, providing an overview of the periods during which the charging point 116 is accessible to users.

Similarly, the apparatus 102 may generate status data for the charging status type by compiling all entries where the start status is designated as “charging.” This classification allows the apparatus 102 to identify the times when the charging point 116 is actively supplying power to EVs.

At 306, a deviation value determination operation is executed. In the deviation value determination operation, the apparatus 102 is configured to determine a number of events corresponding to each of the one or more status types. Further, the apparatus 102 is configured to determine a deviation value associated with each of the one or more status types based on the one or more periods and the number of events. The number of events corresponding to a specific status type may indicate the frequency of occurrence of the specific status type or how often the specific status type occurs. This may indicate the usage patterns and performance of the charging point 116.

For example, the apparatus 102 may determine from the charging point data 118 that the charging point 116 was in the charging status type for 150 events over a month, in the available status type for 200 events over the month, and in the uncertain status type for 20 events over the month.

In addition to counting the number of events, the apparatus 102 is also configured to determine a deviation value associated with each status type of the one or more status types. This deviation value reflects variability in the duration of each status type based on the number of events and the periods during which these statuses were recorded. For example, if the charging point 116 typically takes 30 minutes to charge an EV, this may indicate that the duration of an occurrence of the charging status type should be 30 minutes. However, there may still be significant fluctuations in the actual durations recorded for occurrences of the charging status type. For example, these deviations may arise due to slow charging connectors, the power required by EVs, the initial charge of EVs, premature ending of charging session, batter specifications, and the like. To this end, the deviation value indicating this variability is determined for the charging status type.

To calculate the deviation value, the apparatus 102 may use a standard deviation formula, which considers the mean duration of multiple occurrences or events of a specific status type and individual durations of each of the multiple events of the specific status type. For instance, if the average charging duration is 30 minutes with a standard deviation of 10 minutes, the deviation value indicates that most charging sessions fall within a range of 20 to 40 minutes, but some may extend beyond this range.

At 308, an error data determination operation may be executed. In the error data determination operation, the apparatus 102 or the processor 202 is configured to determine the error data 112 based on the deviation value and the number of events. In an embodiment, the error data 112 is a standard error of a specific status type for a charging point, where the standard error is a ratio of the deviation value of the specific status type and a value or a number based on the number of events associated with the specific status type. This error data 112 for the specific status type may indicate a quantitative measure of variability in the calculated or predicted duration of an occurrence of the specific status type at the charging point 116. Specifically, the error data 112 reflects how much the duration of the specific status type fluctuates based on the frequency, i.e., the number of events, and the deviation value, i.e., the typical standard deviation in each occurrence or event. For instance, a higher error value in the error data 112 for the specific status type may indicate greater variability in the execution of the specific status type, suggesting that the duration for which the specific status type may occur at the charging point 116 may vary greatly.

In an example, the apparatus 102 may be configured to determine a standard error of the error data 112 associated with a specific status type of the charging point 116 based on the following formula:

$${E}_{ci} = \frac{{σ}_{ci}}{\sqrt{{n}_{ci}}} \qquad ( 1 )$$

In the formula above, E is the standard error, c is a specific charging point, σ is the deviation value of the specific status type, i is the specific status type of the one or more status types, and n is the number of events associated with the specific status type.

In an example, the charging point 112 may have recorded data over a month, showing 150 events for the charging status type with a deviation value of 5 minutes, 200 events for the available status type with a deviation value of 7 minutes, and 20 events for the uncertain status type with a deviation value of 10 minutes. Using the formula, the apparatus 102 calculates the error for each status type of the one or more status types. For example, an error value for the charging status type is approximately 0.41 minutes, an error value for the available status type is about 0.49 minutes, and an error value for the inoperative status type is 2.24 minutes. These error values indicate an expected variability in the duration of each status type of the one or more status types, with the higher error for the inoperative status suggesting greater unpredictability in the reasons for inoperability.

At 310, a median period data determination operation may be executed. In the median period data determination operation, the apparatus 102 may be configured to determine median period data associated with each of the one or more status types based on the one or more periods. In an example, the apparatus 102 is configured to calculate the median period data associated with each of the one or more status types based on the recorded periods of those statuses. The median period data indicates a typical duration of each status type, helping the apparatus 102 understand the average performance of the charging point 116 over time. To determine the median period data, the apparatus 102 first collects the duration data for each status type from the charging point data 118. For example, consider the charging point 116 which has recorded the following durations for various status types: charging status type duration of 25 minutes, 30 minutes, 28 minutes, 35 minutes, and 40 minutes; available status durations of 10 minutes, 15 minutes, 12 minutes, 20 minutes, and 18 minutes; and uncertain status durations of 5 minutes, 7 minutes, 6 minutes, 8 minutes, and 10 minutes. The apparatus 102 organizes this data in ascending order and identifies a median for each status type of the one or more status types. For example, a median time is 30 minutes for the charging status type, a median time is 15 minutes for the available status type, and a median time is 7 minutes for the uncertain status type. By determining the median period data for each status type of the one or more status types, the apparatus 102 may determine the typical duration associated with each status type.

At 312, an elapsed period data determination operation may be executed. In the elapsed period data determination operation, the apparatus 102 may be configured to determine elapsed period data for each one of the one or more status types. The elapsed period data indicates the amount of period elapsed since an occurrence of a status type that directly precedes a starting time of a specific status type.

For instance, the charging point 116 transitions from an available status type to a charging status type indicating that the charging point 116 is currently operating in the charging status type. The elapsed period data would capture the amount of time that has elapsed from the moment the status of the charging point 116 transitioned to charging, i.e., from the moment the charging point 116 began charging. This information helps in analyzing the efficiency of the charging process and the responsiveness of the charging infrastructure. By determining the elapsed period for each status type, the apparatus 102 can identify patterns in how quickly the charging point 116 is utilized after becoming available, as well as how long it remains in each status before transitioning to another.

In an example, the median period data may indicate that a median time for the charging status type is 30 minutes. Further, the charging status type may have started at 9:05 AM and the current time may be 9:20 AM. To this end, the amount of period elapsed since an occurrence or the start of the charging status type maybe 15 minutes. In this case, the elapsed period data for the charging status type would indicate that 15 minutes has elapsed since a preceding status before the charging status was transformed to the charging status type.

At 314, a status period data determination operation may be executed. In the status period determination operation, the apparatus 102 is configured to determine the status period data 114 based on the median period data, the elapsed period data, and the error data 112. By integrating the median period data, the elapsed period data, and the error data 112, the apparatus 102 may estimate of how long each status type is likely to persist. The status period data 114 may include a status period associated with each of the one or more status types, such as charging status type, available status type, or uncertain status type. The status period for a specific status type may be calculated based on following formula:

SP_{ci}=(tₘ−tₙ)+E_{ci} (2)

In the formula above, SP is the status period, c is a specific point, i is the specific status type of the one or more status type, tₘ is the median period associated with the specific status type, tₙ is the elapsed period since the last occurrence of the specific status type, and E is the standard error.

The inclusion of error in the calculation accounts for the variability and uncertainty inherent in the data, providing a range within which the actual status period is likely to fall. For example, consider a specific charging point such as the charging point 116 with a median charging duration (Tₘ) of 30 minutes and an elapsed time (Tₙ) since the last charging status of 10 minutes, with a calculated error of 2 minutes. The expected status period for the charging status may be determined and, resulted in a range of 18 to 22 minutes. The status period data 114 provides a clearer understanding of how long they may expect the charging point 116 to remain in a specific status, which is used for managing user expectations and optimizing the charging process.

At 316, a status period data output operation may be executed. In the status period data output operation, the apparatus 102 is configured to output the status period data 114. In an embodiment, the output module 202C of the processor 202 is configured to output the status period data 114. In an embodiment, the output of the status period data 114 may correspond to rendering a status period associated with each of the one or more status types on a user device associated with a user of an EV. In an embodiment, the use device may be a client device, such as a thin client device, a mobile devi frame computer, a desktop computer, and the like. In an embodiment, processor 202 may be configured to provide the status period data 114 as an option for selection by the user. In an embodiment, the status period data 114 may be displayed on a display screen associated with the infotainment system or the user device (such as a mobile phone). In another example, the user may be using an audio signal, thereby rendering the status period a 114 via a set of speakers associated with the infotainment system or the user device.

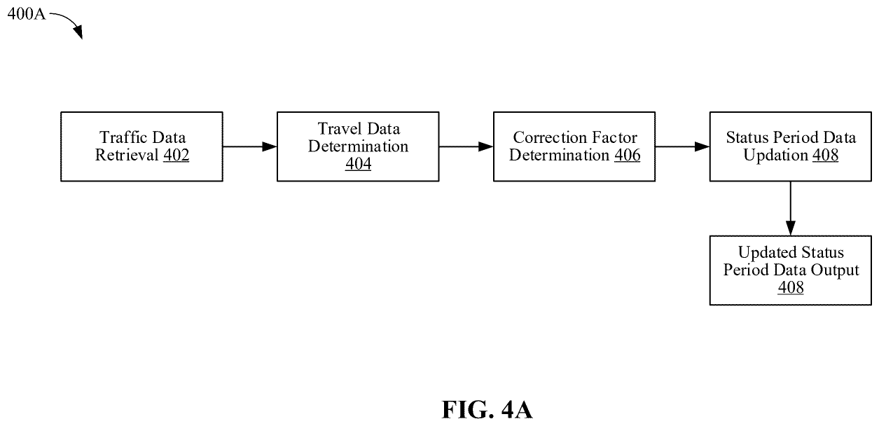

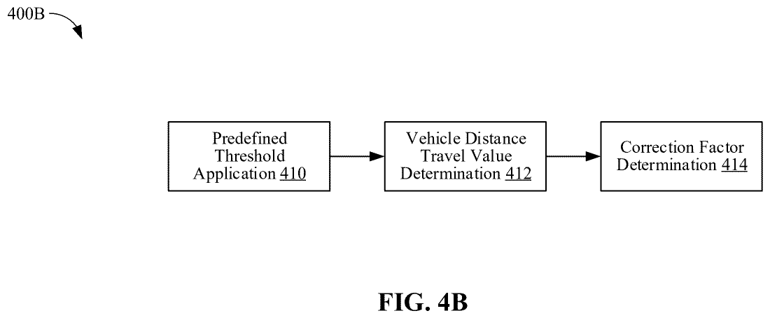

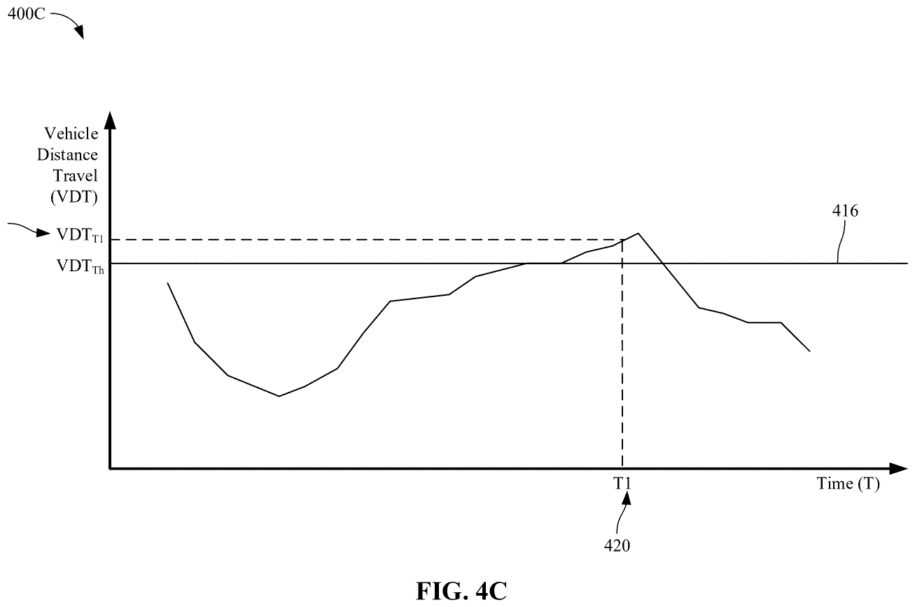

FIG. 4A is a block diagram 400A that illustrates exemplary operations for updating the status period data 114 associated with the charging point 116, in accordance with an embodiment of the disclosure. FIG. 4A is explained in conjunction with elements from FIG. 1, FIG. 2, and FIG. 3. With reference to FIG. 4A, there is shown the block diagram 400A that illustrates exemplary operations from 402 to 408, as described herein. The exemplary operations illustrated in the block diagram 400A may start at 402 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 400A may be divided into additional blocks, combined into fewer blocks, or eliminated, depending on the particular implementation.

At 402, a traffic data retrieval operation may be executed. In the traffic data retrieval operation, the apparatus 102 is configured to retrieve traffic data associated with a geographical region based on the charging point data 118. The traffic data indicates the number of vehicles traveling in the geographical region. In another embodiment, the input module 202A of the processor 202 is configured to retrieve the traffic data associated with the geographical region based on the charging point data 118. In another embodiment, the traffic data may be retrieved from the mapping platform 108.

The traffic data may include metrics such as, but not limited to, daily traffic counts, peak traffic hours, and patterns of vehicle movement in relation to the locations of charging points. The retrieved traffic data may include average daily traffic volumes, which help identify high-demand areas for charging point 116, as well as insights into the types of vehicles passing through the region, particularly the proportion of electric vehicles. Additionally, the traffic data may reveal trends over time, such as seasonal variations or changes in traffic patterns due to new developments or infrastructure projects.

In an embodiment, the charging point data 118 includes geographical region data associated with the geographical region of the charging point 116. In an embodiment, The geographical region data is used to analyze the context in which the charging point 116 operates, such as insights into the location's characteristics, accessibility, and potential user demographics. The geographical region data may include one or more link segments that define the physical boundaries and connectivity of the geographical region surrounding the charging point 116. For example, the link segments are segments of roadways or pathways that connect different locations within the geographical region. These segments may indicate the accessibility of the charging point 116, including the types of roads leading to it, traffic patterns, and the proximity to major thoroughfares or public transportation options.

In addition to link segments, the geographical region data may include information such as land use data, nearby amenities, and environmental data. For instance, land use data can indicate whether the charging point 116 is located in a commercial area, residential neighborhood, or near recreational facilities. This information may help to assess the potential demand for charging services based on the types of activities that occur in the vicinity. Nearby amenities, such as restaurants, shopping centers, or public parks, may also indicate potential demand for charging services at the charging point 116, as users may prefer to charge their vehicles while engaging in other activities. Furthermore, the geographical region data may include environmental data, such as weather conditions, which can influence charging behavior.

At 404, a travel data determination operation may be executed. In the travel data determination operation, the apparatus 102 may be configured to determine travel data for each one of a plurality of predefined periods based on the traffic data. The travel data indicates a distance traveled by one or more vehicles within the geographical region during said one of the plurality of predefined periods. For example, the travel data may indicate a number of vehicles traveling in the geographical region within a predefined period of the plurality of predefined periods. For instance, the predefined period may correspond to a 15-minute period. In an example, the apparatus 102 may be configured to determine the travel data for each 15-minute period over a 24-hour period.

The travel data also provides insights into the distance traveled by one or more vehicles within the geographical region during the plurality of predefined periods. In an embodiment, the processor 202 of the apparatus 102 is configured to analyze the traffic data to extract meaningful travel metrics that reflect vehicle movement patterns during the predefined period. For instance, the travel data may correspond to the number of vehicles traveling within the geographical region during a particular predefined period, which may be a 15-minute period. Further, the processor 202 is configured to determine the total distance traveled by each vehicle of the number of vehicles within the geographical region during the particular predefined period. The total number of vehicles in the geographical region and the distance traveled by vehicles in the geographical region during the particular predefined period may indicate, for example, peak travel times, average distances traveled, traffic congestion, identifying high-traffic areas, and optimizing the placement of charging stations, and overall traffic trends within the geographical region.

To this end, the travel data indicates the dynamics of vehicle movement in the geographical region. For example, if the travel data indicates that a significant number of vehicles travel through a particular region during specific times of the day, this information can guide decisions regarding infrastructure improvements, such as adding more charging stations or enhancing roadways to accommodate increased traffic. Additionally, the travel data may help in forecasting future demand for electric vehicle charging, allowing operators to better manage resources and ensure that charging points are available where and when they are needed most.

At 406, a correction factor determination operation may be executed. In the correction factor determination operation, the apparatus 102 may be configured to determine a correction factor for a first predefined period among the plurality of predefined periods based on the travel data. In an example, the correction factor may correspond to a factor that may affect the status period data 114 for the first predefined period. By determining the correction factor, the apparatus 102 is configured to refine the accuracy of the status period data 114, which indicates the expected duration of each status type of the one or more status types associated with the charging point 116.

In an embodiment, the correction factor may correspond to various elements that may affect the status period data 114, such as fluctuations in traffic volume, changes in user behavior, or external factors like weather conditions. For instance, if the travel data indicates a significant increase in vehicle traffic during the first predefined period, the apparatus 102 may determine that the status period data associated with the charging point 116 in that geographical region should be adjusted to account for the higher demand. Conversely, if travel data shows a decrease in vehicle movement, the correction factor may suggest a shorter expected status period for each of the one or more status types associated with the charging point 116, reflecting reduced usage.

For example, if historical data reveals that charging points are frequently occupied for longer durations during peak traffic times, the apparatus 102 may apply this insight to adjust the status period data 114 accordingly. This dynamic adjustment ensures that the charging infrastructure remains responsive to real-time conditions, enhancing user experience by providing more accurate information about charging availability.

Moreover, the correction factor can also account for other situational variables, such as special events in the geographical region that may lead to increased vehicle traffic or changes in local regulations affecting parking and charging. By incorporating these factors into the correction factor determination, the apparatus 102 can provide a more nuanced understanding of how various elements impact the operational status of charging points. Details associated with the determination of the correction factor are further described in conjunction with FIG. 4B.

At 408, a status period data updating operation may be executed. In the status period data updating operation, the apparatus 102 may be configured to update the status period data 114 associated with each of the one or more status types based on the correction factor.

The apparatus 102 may use the correction factors determined from the travel data to adjust the expected duration or status period of each status type of the one or more status types. For instance, if the correction factor indicates that the charging point 116 is experiencing increased demand during peak traffic hours, the apparatus 102 may update the status period data 114 to reflect a longer expected duration for the “charging” status type. Conversely, if the correction factor suggests a decrease in vehicle activity, the apparatus 102 may shorten the expected duration for the “available” status, indicating that the charging point is likely to be unoccupied for a shorter period.

Moreover, the status period data updating operation may also incorporate feedback loops, where historical performance data is analyzed to refine future correction factors. For example, if the apparatus 102 analyzes that the updated status period data consistently aligns with actual usage patterns, the apparatus 102 may further validate the effectiveness of the correction factors applied. This iterative process not only improves the accuracy of the status period data but also enhances the overall efficiency of the charging network.

At 410, an updated status period data output operation may be executed. In the updated status period data output operation, the apparatus 102 may be configured to output the updated status period data. The output of the updated status period data may take various forms, depending on the intended audience and application. For instance, the apparatus 102 may transmit the updated status period data to the database 106, where it can be accessed by operators for monitoring and management purposes. This centralized access allows operators to make informed decisions regarding resource allocation, maintenance scheduling, and operational adjustments based on real-time data. Additionally, the updated status period data can be integrated into user-facing applications, such as mobile apps or mapping platforms 108, providing EV users with timely information about charging point availability.

For example, the updated status period data output operation may involve formatting the data in a user-friendly manner, ensuring that it is easily interpretable by both technical and non-technical users. For example, the updated status period data may be presented in a dashboard format that highlights the current status of each charging point, along with the estimated duration for which each status is expected to persist. This visual representation can enhance user experience by allowing EV users to quickly assess which charging points are available and for how long. Moreover, the apparatus 102 may also implement notification systems that alert users when charging points transition between statuses or when the expected availability changes. For instance, if a charging point that was previously marked as “available” is updated to reflect a longer “charging” status due to increased demand, users who are nearby could receive real-time notifications through their mobile devices.

FIG. 4B is a block diagram 400B that illustrates exemplary operations for determining a correction factor associated with a first predefined period of a plurality of predefined periods, in accordance with an embodiment of the disclosure. FIG. 4B is explained in conjunction with elements from FIG. 1, FIG. 2, FIG. 3, and FIG. 4A. With reference to FIG. 4B, there is shown the block diagram 400B that illustrates exemplary operations from 412 to 416, as described herein. The exemplary operations illustrated in the block diagram 400B may start at 410 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 400B may be divided into additional blocks, combined into fewer blocks, or eliminated, depending on the particular implementation.

In an embodiment, the travel data for each of the plurality of predefined periods defines, in part, a travel graph data including a travel plot. This travel graph visually represents the movement patterns of vehicles within the geographical region over time, allowing for a clear understanding of traffic dynamics. Each predefined period, such as 15-minute intervals, is plotted on the graph, showcasing metrics such as the number of vehicles traveling and the distances covered during those intervals. In one embodiment, a travel graph data is generated for a charging point, where the travel graph data plots vehicle distance travel values over the plurality of predefined periods. In such embodiment, the vehicle distance travel values indicate aggregated distances covered by a total number of vehicles that traversed specific links within a predefined zone over the plurality of predefined periods. In such embodiment, the specific links are functional class 1 and functional class 2 type links (e.g., interstates, freeways, and principal arterials), and the predefined zone includes the charging point. In one embodiment, the predefined zone is defined as a tile of a tile-based mapping system that provides a detailed street-level view. In one embodiment, the tile level of the predefined zone may be level 15, thus covering 1.2 km×1.2 km of real-world space. In alternative embodiment, the tile level may be level 14 or level 16. In alternative embodiments, the boundary of the predefined zone may be other shapes, such as a circle, and the radius of the circle may be 1.2 km. The travel plot can reveal trends, such as peak travel times and fluctuations in vehicle activity. By analyzing this travel graph data, decision-makers can optimize the placement of charging point 116. Further details of the travel graph are described in conjunction with FIG. 4C.

At 410, a predefined threshold application operation may be executed. In the predefined threshold application operation, the apparatus 102 may be configured to apply one or more predefined thresholds to the travel graph data. The one or more predefined thresholds are applied for identifying significant trends, anomalies, or patterns in travel behavior that may impact the efficiency and utilization of EV charging infrastructure in any one of the plurality of predefined periods. By establishing the one or more predefined thresholds, the apparatus 102 may set benchmarks against which the travel data can be evaluated, allowing for more informed decision-making.

For instance, a specific predefined threshold may be applied to the travel graph data over a period, such as 24 hours. In one embodiment, a predefined threshold may be one standard deviation above the mean of vehicle distance travel values over the period or one standard deviation below the mean. In an embodiment in which two predefined thresholds are established, one of the thresholds is one standard deviation above the mean, and the other one of the thresholds is one standard deviation below the mean. If a vehicle distance travel value for a predefined period exceeds the predefined threshold (e.g., the one standard deviation above the mean) in a predefined period, it may indicate unusually high demand for charging services in the predefined period, which will affect status period data associated with a status type in the predefined period.

At 412, a vehicle distance travel value determination operation may be executed. In the vehicle distance travel value determination operation, the apparatus 102 may be configured to determine a vehicle distance travel value associated with the first predefined period based on the travel graph data. In one embodiment, the first predefined period may be a period of interest. In one embodiment, the first predefined period may correspond to a status period. For example, if a user wishes to know a status period of a charging point at a specific time and a correction factor is being applied to the status period, the first predefined period includes the specific time to ensure that the correction factor is relevant for determining the status period of the charging point.

At 414, a correction factor determination operation may be executed. In the correction factor determination operation, the apparatus 102 may be configured to determine the correction factor based on one of the one or more predefined thresholds and the vehicle distance travel. In an embodiment, if the vehicle distance travel value satisfies one of the one or more predefined thresholds, the apparatus 102 may be configured to determine the correction factor based on said one of the one or more predefined thresholds and the vehicle distance travel value. For example, if a vehicle distance travel value exceeds a predefined threshold that is one standard deviation above the mean of vehicle distance travel values over a period, the vehicle distance travel value satisfies the predefined threshold, and the correction factor is defined as a function of the vehicle distance travel value and the predefined threshold. By way of another example, if a vehicle distance travel value is below a predefined threshold that is one standard deviation below the mean of vehicle distance travel values over a period, the vehicle distance travel value satisfies the predefined threshold, and the correction factor is defined as a function of the vehicle distance travel value and the predefined threshold. The processor 202 within the apparatus 102 analyzes this relationship, using the predefined threshold as a benchmark to assess the significance of the vehicle distance travel value.

In one embodiment, the correction factor is a ratio of a predefined threshold that is satisfied by a vehicle distance value (e.g., the vehicle distance value exceeds a predefined threshold that is one standard deviation above the mean of vehicle distance travel values over a period or the vehicle distance value is below the predefined threshold that is one standard deviation below the mean) and the vehicle distance value. In one embodiment, the formula for calculating the correction factor is given by the following equation:

$$F = \frac{{VDT}_{th}}{VDT} \qquad ( 3 )$$

In the equation above, F is the correction factor, VDTₜₕ is a value of a specific predefined threshold of the one or more predefined thresholds that have been met, and VDT is the vehicle distance travel value associated with the first predefined period of the plurality of the predefined periods.

In this equation, F serves as a corrective multiplier that adjusts the status period data. For example, a status period may be divided by a value of the correction factor, F, to correct the status period for the first predefined period. When a vehicle distance travel value exceeds a predefined threshold that is one standard deviation above the mean of vehicle distance travel values over a period, the value of F will be less than 1 but greater than 0, indicating that the status period should be increased due to heightened demand for charging services. When a vehicle distance travel value is below a predefined threshold that is one standard deviation below the mean of vehicle distance travel values over a period, the value of F will be greater than 1, thus indicating that the status period should be decreased due to decreased demand for charging services.

For example, if a predefined threshold is set at 100 kilometers and the observed VDT is 120 kilometers, the apparatus 102 determines that the correction factor is equal to 100/120-0.833. In this case, the status period may be penalized, effectively increasing it to account for the higher volume of vehicles seeking charging services. Conversely, if the VDT does not exceed the threshold, the status period is not adjusted.

When a status period is divided by a correction factor, it results in an increased status period associated with a corresponding status type, reflecting a reality of higher demand. For instance, if a status period associated with the available status type is 10 minutes, and the correction factor is determined to be 0.833, the updated status period associated with the available status type is equal to 10/0.833-12 min. This adjustment ensures that users are aware of potential delays and can plan their charging sessions accordingly.

FIG. 4C is a diagram that illustrates a graphical representation of travel graph data 400C, in accordance with an embodiment of the disclosure. FIG. 4C is explained in conjunction with elements from FIG. 1, FIG. 2, FIG. 3, FIG. 4A, and FIG. 4B.

In an embodiment, the travel graph data 400C provides insights into vehicle distance travel values over a period, which are compared against a specific predefined threshold VDT_{Th} 416. The VDT_{Th} 416 serves as a benchmark for evaluating vehicle activity within a geographical region. In the illustrated embodiment, VDT_{Th} 416 is one standard deviation above the mean of the vehicle distance travel values over the period. In the illustrated embodiment, the apparatus receives an input requesting a status period at a time instant T₁ 420 with a correction factor applied to the status period. In response, the apparatus 102 determines a vehicle distance travel value VDT_{T1} 422 that corresponds to the time instant T₁ 420. The apparatus 102 then determines the correction factor at T1 420 using the formula: F=VDT_{Th}/VDT_{T1}.

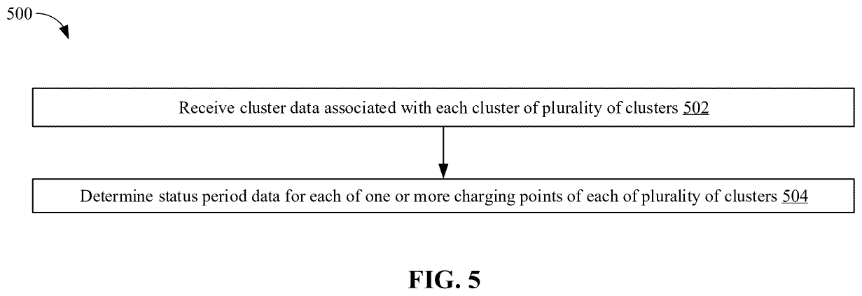

FIG. 5 is a flowchart 500 that illustrates an exemplary method for determining status period data for a plurality of clusters, in accordance with an embodiment of the disclosure. FIG. 5 is explained in conjunction with elements from FIG. 1, FIG. 2, FIG. 3, FIG. 4A, FIG. 4B, and FIG. 4C. With reference to FIG. 5, there is shown the flowchart 500. The operations of the exemplary method may be executed by any computing system, for example, by the apparatus 102 of FIG. 1 or the processor 202 of FIG. 2. The operations of the flowchart 500 may start at 502.

At 502, cluster data associated with each cluster of the plurality of clusters is received. In an embodiment, the apparatus 102 may be configured to receive the cluster data associated with each cluster of the plurality of clusters. In an embodiment, each cluster of the plurality of clusters may include one or more charging points. For example, a cluster of the plurality of clusters comprises the charging point 116. In some cases, a cluster may correspond to a cluster of charging stations present in a predefined area, such as a city or a part of the city. Subsequently, the one or more charging points of the cluster may be associated with the same charging station or different charging stations. The cluster data includes information for understanding different status types and characteristics of each charging point of the plurality of charging points in each cluster of the plurality of clusters.

For example, the cluster data for a cluster may include charging point data associated with each of the one or more charging points in the cluster. The cluster data for a cluster may include details such as, but are not limited to, the location ID of each of one or more charging points, the charging point ID of each of the one or more charging points, types of charging connector(s) at each of the one or more charging points, a power output of each of the one or more charging points, and status type data associated with each of the one or more charging points. The status type data may indicate current status of each of the one or more charging points (e.g., available, in use, or out of service), historical usage patterns, average charging times, and user feedback, all of which contribute to a comprehensive understanding of how each of the one or more charging points is utilized.

At 504, status period data for each of the one or more charging points of each of the plurality of clusters is determined. In an embodiment, the apparatus 102 may be configured to determine the status period data for each of the one or more charging points of each of the plurality of clusters.

In an embodiment, the apparatus 102 may be configured to generate the plurality of clusters based on the cluster data and one or more predefined clustering features. The clustering is a data analysis technique that groups similar data points based on specific characteristics or features. In the context of the cluster data, predefined clustering features may include factors such as geographical location, charging point type (e.g., fast chargers, standard chargers), usage frequency, power output, and proximity to amenities (e.g., shopping centers, and restaurants). By applying these features, the apparatus 102 may categorize charging points into distinct clusters that share similar attributes, making it easier to analyze their performance and utilization. For example, the apparatus 102 may identify clusters of charging points located in high-traffic urban areas, which may exhibit different usage patterns compared to those in suburban or rural settings. By analyzing these clusters, operators can gain insights into how location affects charging behavior, allowing them to make informed decisions about where to deploy additional charging infrastructure or enhance existing services.

The clustering process may involve various algorithms, such as K-means clustering, hierarchical clustering, or density-based spatial clustering. These algorithms analyze the charging point data and group the points based on the selected features, ensuring that points within the same cluster are more similar to each other than to those in other clusters. The choice of algorithm and the number of clusters can be adjusted based on the specific goals of the analysis and the nature of the data. Once the clusters are generated, the apparatus 102 may visualize the results, providing operators with a clear representation of the charging point landscape. This visualization may highlight areas of high demand, underutilized charging points, and potential gaps in the charging network. Furthermore, the clustering results can be used to inform users about charging point availability and suitability. For instance, if a cluster of fast chargers is identified in a busy area, the apparatus 102 may promote these locations to EV users, ensuring they are aware of the most convenient and efficient charging options available.

Further, the apparatus 102 is configured to determine the status period data for each charging point in each cluster of the plurality of clusters. A manner in which the status period data is determined is described in detail in conjunction with FIG. 1, FIG. 2, FIG. 3, and FIG. 4A-FIG. 4C.

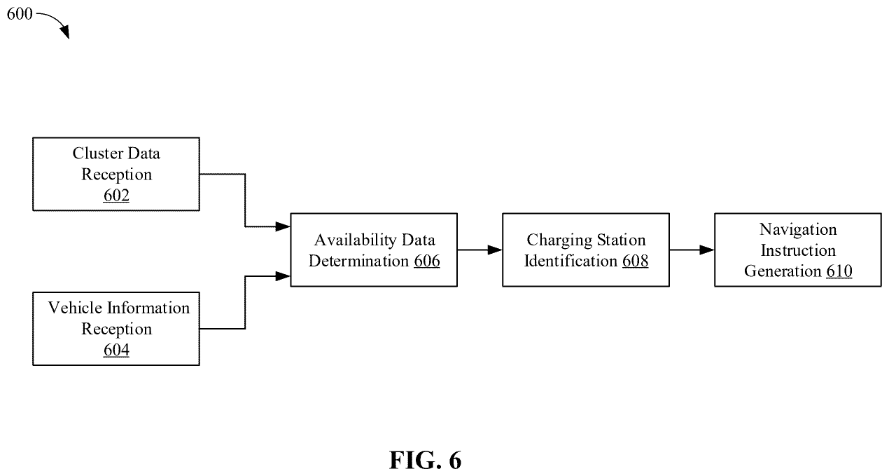

FIG. 6 is a block diagram 600 that illustrates exemplary operations for generating navigation instructions for a vehicle, in accordance with an embodiment of the disclosure. FIG. 6 is explained in conjunction with elements from FIG. 1, FIG. 2, FIG. 3, FIG. 4A, FIG. 4B, FIG. 4C and FIG. 5. With reference to FIG. 6, there is shown the block diagram 600 that illustrates exemplary operations from 602 to 610, as described herein. The exemplary operations illustrated in the block diagram 600 may start at 602 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 600 may be divided into additional blocks, combined into fewer blocks, or eliminated, depending on the particular implementation.

At 602, a cluster data reception operation may be executed. In the cluster data reception operation, the apparatus 102 may be configured to receive the cluster data associated with each cluster of the plurality of clusters. Each cluster of the plurality of clusters includes one or more charging points. A cluster of the plurality of clusters includes the charging point 116. The cluster data includes various attributes related to a corresponding cluster, including the one or more charging points of the cluster, geographical locations of each of the one or more charging points, usage statistics of each of the one or more charging points, and operational statuses or status type data for each of the one or more charging points. Each cluster may consist of one or more charging points that share similar characteristics based on the predefined clustering features, such as type of charger, frequency of use, and proximity to key amenities. For instance, a cluster may include fast chargers located near a shopping center, while another cluster may consist of standard chargers situated in residential areas. Further details of cluster data are described in conjunction with FIG. 5.

At 604, a vehicle information reception operation may be executed. In the vehicle information reception operation, the apparatus 102 may be configured to receive vehicle information of the vehicle. The vehicle information includes location data and battery charge data. The location data provides real-time information about the vehicle's geographical position. The location data is typically obtained through GPS technology, which allows the apparatus 102 to pinpoint the vehicle's current location with high accuracy. By knowing where the vehicle is situated, the apparatus 102 may assess the proximity of nearby charging points.

The vehicle information includes battery charge data, which indicates the current state of charge of the vehicle's battery. The battery charge data is used to understand how much energy the vehicle has left and how urgently it needs to be charged. For instance, if the battery charge data shows that the vehicle is running low on power, the apparatus 102 prioritizes nearby charging points and provides real-time updates on their availability. Conversely, if the battery charge is sufficient, the apparatus 102 may suggest alternative charging options or inform the driver that immediate charging is not necessary.

The reception of this vehicle information can occur through various means, such as direct communication between the vehicle and the apparatus 102 via wireless protocols (e.g., Bluetooth, Wi-Fi, or cellular networks).

At 606, an availability data determination operation may be executed. In the availability data determination operation, the apparatus 102 may be configured to determine availability data associated with each of the one or more charging points within each of the plurality of clusters based on the status period data for each of the one or more charging points of each of the plurality of clusters.

The availability data for a charging point of a cluster is derived from the status period data of the charging point, which reflects the operational state of the charging points over time. The status period data may include a status period for various status types such as “available,” “in use,” “out of service,” or “charging.” By analyzing the status period data, the apparatus 102 may ascertain the current availability of each charging point within the clusters, allowing it to provide accurate and timely information to the EV users. To determine the availability data, the apparatus 102 first reviews the status period data 114 for each charging point within the clusters. This data may be updated in real time, reflecting changes in the operational status of the charging points as vehicles connect and disconnect. For instance, if a charging point was previously marked as “in use” but has recently become available, the apparatus 102 may update its availability data accordingly.

The apparatus 102 may also consider additional factors that could influence availability, such as scheduled maintenance, power outages, or other operational issues. By integrating this contextual information, the apparatus 102 provides a more comprehensive view of charging point availability, helping users avoid potential inconveniences. The availability data provides real-time insights into the operational status of charging points within each cluster, indicating which points are currently available for use.

At 608, a charging station identification operation may be executed. In the charging station identification operation, the apparatus 102 may be configured to identify at least one charging point from at least one cluster of the plurality of clusters for the vehicle based on the vehicle information and the availability data. In an embodiment, the apparatus 102 may be configured to identify a particular charging point from one or more charging points of a cluster of the plurality of clusters for the vehicle based on the vehicle information, the availability data, and the status period data. The apparatus 102 analyzes the vehicle information including the vehicle's location data and battery charge status. By understanding where the vehicle is currently situated and how much charge remains in its battery, the apparatus 102 may determine the urgency of the charging requirement. Further, based on the availability data, the apparatus 102 may identify nearby charging point(s) that are available or may become available soon for charging. For instance, if the vehicle is low on battery, the apparatus 102 may prioritize identifying a charging point that is nearby and is available for charging. By filtering the charging points based on their availability, the apparatus 102 may quickly eliminate any options that are currently in use or out of service, ensuring that the recommendations provided to the user are practical and actionable. Alternatively, if the vehicle has enough battery charge, the apparatus 102 may identify a charging point that is enroute to the destination of the vehicle, or that is present near a rest stop or a landmark (such as, a home, office, restaurant, movie theatre, park, and so forth) so that a user of the vehicle can utilize a time during which the EV can be charged.

The apparatus 102 may also consider additional factors during the identification process, such as the type of charger required by the vehicle, a charging speed (e.g., fast charging versus standard charging), and any preferences indicated by the user. For example, if the vehicle requires a specific type of connector or if the driver prefers fast charging options, the apparatus 102 further refines its search to identify only those charging points that meet these criteria.

At 610, a navigation instruction generation operation may be executed. In the navigation instruction generation operation, the apparatus 102 may be configured to generate navigation instructions for the vehicle from a starting location to one of the at least one identified charging point. In at least one embodiment, the processor 202 of the apparatus 102 may be configured to generate navigation instructions for the vehicle from a starting location to one of the at least one identified charging point.

The apparatus 102 may utilize the vehicle's current location data. This data serves as the starting point for the navigation instructions. The apparatus 102 then references the availability data and the identified charging points to determine the most suitable charging station for the vehicle based on its current needs and preferences. Once a charging point is identified, the apparatus 102 employs mapping and navigation algorithms to generate detailed navigation instructions. These navigation instructions typically include turn-by-turn directions, estimated travel time, and distance to the charging point. The apparatus 102 may also consider real-time traffic conditions, road closures, and other factors that could affect the route, ensuring that the navigation instructions are as accurate and efficient as possible.

The generated navigation instructions can be presented to the driver through various interfaces, such as a mobile application or the vehicle's onboard navigation system. This integration allows for a user-friendly experience, enabling drivers to follow the instructions easily while focusing on the road. Additionally, the apparatus 102 may provide supplementary information, such as the estimated status period at the charging point, the type of charger available, and any amenities nearby.

In one embodiment, the navigation instructions may be used as inputs for autonomously maneuvering a vehicle to the location of the identified charging point. Such instructions may be provided to an Autonomous Driving System (ADS) of the vehicle, thereby enabling the vehicle to autonomously traverse a route to the identified charging point as indicated by the instructions.

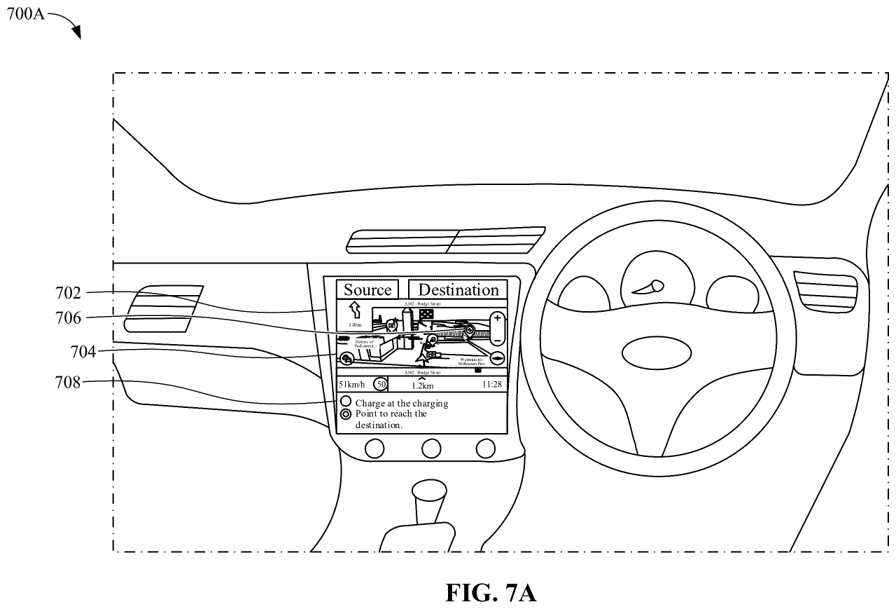

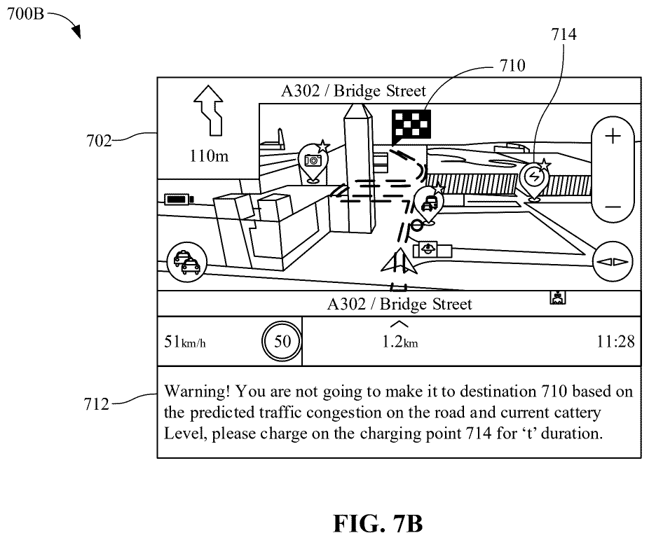

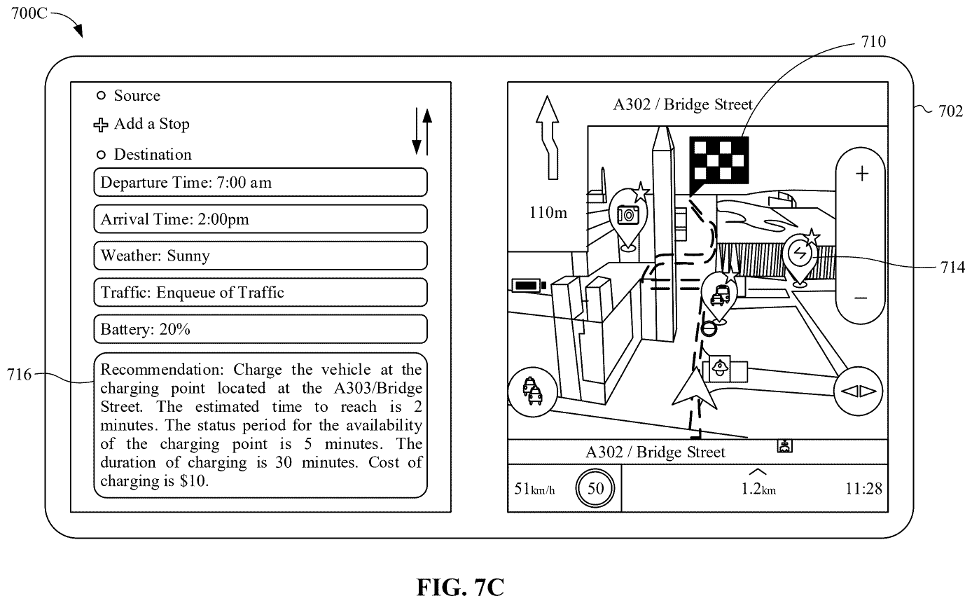

FIG. 7A is a diagram that illustrates a first user interface associated with rendering the status period data for a vehicle, in accordance with an embodiment of the disclosure. FIG. 7A is explained in conjunction with elements from FIG. 1, FIG. 2, FIG. 3, FIG. 4A, FIG. 4B, FIG. 4C, FIG. 5, and FIG. 6. With reference to FIG. 7A, there is shown the example scenario 700A that includes an interior cabin of an EV. There is further shown, a display screen 702 of an infotainment system.

In an embodiment, the apparatus 102 may be configured to output the status period data 114 associated with each status type of the one or more status types on the display screen 702. Based on the EV battery status, the apparatus 102 may be configured to generate a recommendation in response to the battery status of the EV and the status period data 114 of the charging point 116. For example, a map 704 may be displayed on the display screen 702. The map 704 may indicate the specific charging point such as the charging point 116 associated with the charging station 110 that may be recommended to the user of the EV for charging the EV. The apparatus 102 may be configured to render a recommendation 708 on the display screen 702 for the user of the specific EV. By way of an example and not limitation, the recommendation 708 may state “Charge at the charging point to reach a destination”. By way of another example and not limitation, the recommendation 708 may state “Charge at the charging point for ‘t’ duration to reach the destination of the specific EV, and the status of the charging point is available for the next 30 minutes”.

FIG. 7B is a diagram that illustrates a second user interface associated with rendering a recommendation for the charging of the vehicle, in accordance with an embodiment of the disclosure. FIG. 7B is explained in conjunction with elements from FIG. 1, FIG. 2, FIG. 3, FIG. 4A, FIG. 4B, FIG. 4C, FIG. 5, FIG. 6, and FIG. 7A. With reference to FIG. 7B, there is shown the exemplary scenario 700B that includes the display screen 702 of the infotainment system. In the illustrated embodiment, there is displayed a map depicting a route to be traversed by the specific EV to reach a destination 710. The illustrated embodiment indicates a scenario in which the apparatus 102 estimated that the predicted driving range of the specific EV is less than the first driving range. As such, the apparatus 102 identified a nearby charging point 714 and generated a recommendation 712 stating “WARNING! You are not going to make it to destination based on the predicted traffic congestion on the road and current battery level. Estimated time to reach charging point is 2 minutes, and the estimated wait time at the charging point is 5 minutes. Please charge at the charging point for 30 minutes.”

FIG. 7C is a diagram that illustrates a third user interface associated with rendering a recommendation for charging a vehicle, in accordance with an embodiment of the disclosure. FIG. 7C is explained in conjunction with elements from FIGS. 1, 2, 3, 4A, 4B, 4C, 5, 6, 7A, and 8B. With reference to FIG. 7C, there is shown the exemplary scenario 700C that includes the display screen 702 of an infotainment system.

For example, as shown in the FIG. 7C, there is displayed a map depicting the route to the destination 710 of the specific EV. The display screen 702 may indicate first temporal information associated with a departure time (such as 7:00 am) from the source of the EV, second temporal information associated with an arrival time (such as 2:00 pm) at the destination 710, weather information associated with the environment around the specific EV (such as sunny), traffic information associated with the route traversed by the specific EV (such as enqueue of traffic), and battery information associated with the battery level of the specific EV (such as 20%).

Based on a prediction indicating that the predicted driving range of the specific EV is less than the first driving range, the apparatus 102 may be configured to generate a recommendation 716. By way of an example and not limitation, the recommendation 716 may state “Charge the vehicle at the charging point located at the A303/Bridge Street. The estimated time to reach is 2 minutes. The status period for the availability of the charging point is 5 minutes. The duration of charging is 30 minutes. Cost of charging is $10.” In an embodiment, based on the generated recommendation 716, the apparatus 102 may be configured to cause the specific EV to navigate to the route after the completion of the charging of the specific EV. In an embodiment, the apparatus 102 may be configured to cause the specific EV to control the at least one vehicle-related function (such as a speed control function, electrical equipment usage, and the like) that may impact the consumption of the battery. In an example embodiment, the apparatus 102 may be configured to activate the cruise control functionality of the specific EV such that the specific EV cruises at a constant speed. This may increase the battery life and the driving range of the specific EV. In another embodiment, the apparatus 102 may turn off the air conditioning system installed in the specific EV to reduce the rate of degradation of the battery of the specific EV. This may increase the driving range of the specific EV.

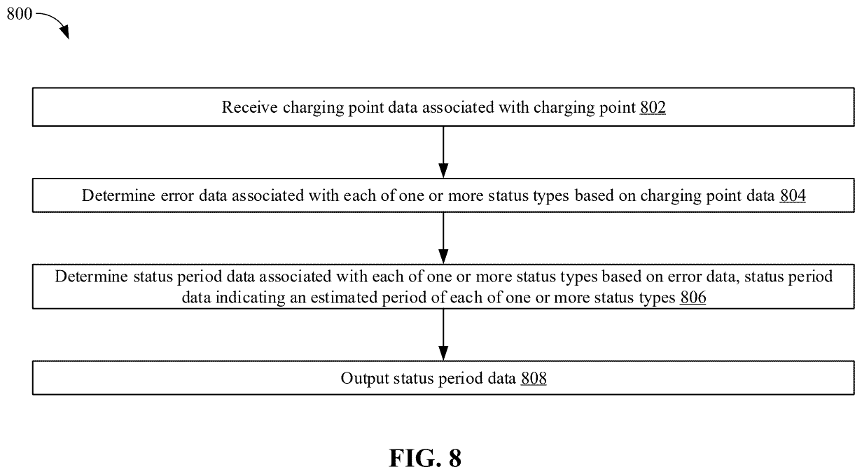

FIG. 8 is a flowchart 800 that illustrates an exemplary method for determining the status period data 114 associated with the charging point 116, in accordance with an embodiment of the disclosure. FIG. 8 is explained in conjunction with elements from FIG. 1, FIG. 2, FIG. 3, FIG. 4A, FIG. 4B, FIG. 4C, FIG. 5, FIG. 6, FIG. 7A, FIG. 7B, and FIG. 7C. With reference to FIG. 8, there is shown the flowchart 800. The operations of the exemplary method may be executed by any computing system, for example, by the apparatus 102 of FIG. 1 or the processor 202 of FIG. 2. The operations of the flowchart 800 may start at 802.

At 802, the charging point data 118 associated with the charging point 116 is received. In an embodiment, the apparatus 102 is configured to receive the charging point data 118 associated with the charging point 116. The charging point data 118 indicates one or more status types associated with the charging point 116 and one or more periods associated with each of the one or more status types. In an example, the one or more status types include a charging status type, an available status type, an unknown status type, an inoperative status type, a blocked status type, or a combination thereof.

At 804, the error data 112 associated with each of one or more status types based on the charging point data 118 is determined. In an embodiment, the apparatus 102 may be configured to determine the error data 112 associated with each of one or more status types based on the charging point data 118. In an embodiment, the apparatus 102 may be configured to determine a number of events corresponding to each of the one or more status types. Further, the processor 202 may configured to determine a deviation value associated with each of the one or more status types based on the one or more periods and the number of events. Furthermore, the processor 202 may be configured to determine the error data 112 based on the deviation value and the number of events. Details associated with the determination of the error data 112 are described in conjunction with, for example, FIG. 3.

At 806, the status period data 114 associated with each of the one or more status types is determined based on the error data 112. In an embodiment, the apparatus 102 is configured to determine the status period data 114 associated with each of the one or more status types based on the error data 112. The status period data 114 indicates an estimated period of each of the one or more status types. The status period data 114 indicates an estimated period of each of the one or more status types. Details associated with the determination of the status period data 114 are described in conjunction with, for example, FIG. 3, FIG. 4A and FIG. 4B.

At 808, the status period data 114 is outputted. In an embodiment, the apparatus 102 may be configured to output the status period data 114 associated with each of the one or more status types.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one non-transitory memory storing computer program code instructions, the computer program code instructions configured to, when executed, cause the apparatus to:
receive charging point data associated with a charging point, wherein the charging point data indicates one or more status types associated with the charging point and one or more periods associated with each of the one or more status types;
determine error data associated with each of the one or more status types based on the charging point data;
determine median period data associated with each of the one or more status types based on the one or more periods;
determine elapsed period data for each one of the one or more status types, wherein the elapsed period data indicates an amount of period elapsed since an occurrence of a status type that directly precedes a starting time of one of the one or more status types;
based on the median period data, the elapsed period data, and the error data, determine status period data associated with each of the one or more status types, the status period data indicating an estimated period of each of the one or more status types;
receive vehicle information for a vehicle, the vehicle information comprising location data and battery charge data;
determine availability data associated with the charging point based on the status period data;
identify the charging point for the vehicle based on the vehicle information and the availability data; and
generate navigation instructions for maneuvering the vehicle from a starting location to the identified charging point.

2. The apparatus of claim 1, wherein the one or more status types comprise a charging status type, an available status type, an unknown status type, an inoperative status type, a blocked status type, or a combination thereof.

3. The apparatus of claim 1, wherein, to determine the error data, the computer program code instructions are configured to, when executed, cause the apparatus to:
determine a number of events corresponding to each of the one or more status types;
determine a deviation value associated with each of the one or more status types based on the one or more periods and the number of events; and
determine the error data based on the deviation value and the number of events.

4. The apparatus of claim 3, wherein the error data is a ratio of the deviation value and a value based on the number of events.

5. (canceled)

6. The apparatus of claim 1, wherein the charging point data comprises geographical region data associated with a geographical region of the charging point.

7. The apparatus of claim 6, wherein the computer program code instructions are configured to, when executed, cause the apparatus to:
retrieve traffic data associated with the geographical region based on the charging point data;
determine travel data for each one of a plurality of predefined periods based on the traffic data, wherein the travel data indicates a distance traveled by one or more vehicles within the geographical region during one of the plurality of predefined periods;
determine a correction factor for a first predefined period of the plurality of predefined periods based on the travel data;
update the status period data associated with each of the one or more status types based on the correction factor; and
output the updated status period data.

8. The apparatus of claim 7, wherein the travel data for each of the plurality of predefined periods defines, in part, travel graph data comprising a travel plot, and wherein the computer program code instructions are configured to, when executed, cause the apparatus to:
apply one or more predefined thresholds to the travel graph data;
determine a vehicle distance travel value associated with the first predefined period of the plurality of predefined periods based on the travel graph data; and
responsive to the vehicle distance travel value satisfying one of the one or more predefined thresholds, determine the correction factor based on said one of the one or more predefined thresholds and the vehicle distance travel value.

9. The apparatus of claim 8, wherein the correction factor is a ratio of said one of the one or more predefined thresholds and the vehicle distance travel value.

10. The apparatus of claim 1, wherein the computer program code instructions are configured to, when executed, cause the apparatus to:
receive cluster data associated with each cluster of a plurality of clusters, wherein each cluster of the plurality of clusters comprises one or more charging points, and wherein a cluster of the plurality of clusters comprises the charging point; and
determine the status period data for each of the one or more charging points of each of the plurality of clusters.

11. (canceled)

12. (canceled)

13. A method comprising:
receiving charging point data associated with a charging point, wherein the charging point data indicates one or more status types associated with the charging point and one or more periods associated with each of the one or more status types;
determining error data associated with each of the one or more status types based on the charging point data;
determining median period data associated with each of the one or more status types based on the one or more periods;
determining elapsed period data for each one of the one or more status types, wherein the elapsed period data indicates an amount of period elapsed since an occurrence of a status type that directly precedes a starting time of one of the one or more status types;
based on the median period data, the elapsed period data, and the error data, determining status period data associated with each of the one or more status types, the status period data indicating an estimated period of each of the one or more status types;
receiving vehicle information for a vehicle, the vehicle information comprising location data and battery charge data;
determining availability data associated with the charging point based on the status period data;
identifying the charging point for the vehicle based on the vehicle information and the availability data; and
generating navigation instructions for maneuvering the vehicle from a starting location to the identified charging point.

14. The method of claim 13, further comprising:
determining a number of events corresponding to each of the one or more status types;
determining a deviation value associated with each of the one or more status types based on the one or more periods and the number of events; and
determining the error data based on the deviation value and the number of events.

15. (canceled)

16. The method of claim 13, further comprising:
retrieving traffic data associated with a geographical region based on the charging point data;
determining travel data for each one of a plurality of predefined periods based on the traffic data, wherein the travel data indicates a distance traveled by one or more vehicles within the geographical region during one of the plurality of predefined periods;
determining a correction factor for a first predefined period of the plurality of predefined periods based on the travel data;
updating the status period data associated with each of the one or more status types based on the correction factor; and
outputting the updated status period data.

17. The method of claim 16, wherein the travel data for each of the plurality of predefined periods defines, in part, a travel graph data comprising a travel plot, and wherein the method further comprising:
applying one or more predefined thresholds to the travel graph data;
determining a vehicle distance travel value associated with the first predefined period of the plurality of predefined periods based on the travel graph data; and
responsive to the vehicle distance travel value satisfying one of the one or more predefined thresholds, determining the correction factor based on said one of the one or more predefined thresholds and the vehicle distance travel value.

18. The method of claim 13, further comprising:
receiving cluster data associated with each cluster of a plurality of clusters, wherein each cluster of the plurality of clusters comprises one or more charging points, and wherein a cluster of the plurality of clusters comprises the charging point; and
determining the status period data for each of the one or more charging points of each of the plurality of clusters.

19. The method of claim 18, further comprising:
receiving vehicle information of a vehicle, wherein the vehicle information comprises location data and battery charge data;
determining availability data associated with each of the one or more charging points within each of the plurality of clusters based on the status period data for each of the one or more charging points of each of the plurality of clusters; and
identifying at least one charging point from at least one cluster of the plurality of clusters for the vehicle based on the vehicle information and the availability data.

20. A computer programmable product comprising a non-transitory computer readable medium having stored thereon computer executable instructions, which when executed by one or more processors, cause the one or more processors to carry out operations comprising:
receiving charging point data associated with a charging point, wherein the charging point data indicates one or more status types associated with the charging point and one or more periods associated with each of the one or more status types;
determining error data associated with each of the one or more status types based on the charging point data;
determining median period data associated with each of the one or more status types based on the one or more periods;
determining elapsed period data for each one of the one or more status types, wherein the elapsed period data indicates an amount of period elapsed since an occurrence of a status type that directly precedes a starting time of one of the one or more status types;
based on the median period data, the elapsed period data, and the error data, determining status period data associated with each of the one or more status types, the status period data indicating an estimated period of each of the one or more status types;
receiving vehicle information for a vehicle, the vehicle information comprising location data and battery charge data;
determining availability data associated with the charging point based on the status period data;
identifying the charging point for the vehicle based on the vehicle information and the availability data; and
generating navigation instructions for maneuvering the vehicle from a starting location to the identified charging point.

21. The computer programmable product of claim 20, wherein the one or more status types comprise a charging status type, an available status type, an unknown status type, an inoperative status type, a blocked status type, or a combination thereof.

22. The computer programmable product of claim 20, wherein, to determine the error data, the computer program code instructions are configured to, when executed, cause the apparatus to:
determine a number of events corresponding to each of the one or more status types;
determine a deviation value associated with each of the one or more status types based on the one or more periods and the number of events; and
determine the error data based on the deviation value and the number of events.

23. The computer programmable product of claim 22, wherein the error data is a ratio of the deviation value and a value based on the number of events.

24. The computer programmable product of claim 20, wherein the charging point data comprises geographical region data associated with a geographical region of the charging point.
